(19) United States
(12) Patent Application Publication
(10) Pub. No.: US 2022/0026061 A1
(43) Pub. Date: Jan. 27, 2022

(54) METHODS AND SYSTEMS FOR RADIOFREQUENCY PLASMA PLUME GENERATION

(71) Applicant: Archer Laboratories, LLC, Albuquerque, NM (US)

(72) Inventors: John Samuel Thurman, Albuquerque, NM (US); Kenneth W. Engeling, Cape Canaveral, FL (US); Rajat Raj Adhikari, Albuquerque, NM (US); Haynes Ray Wood, Corrales, NM (US)

(21) Appl. No.: 17/443,760

(22) Filed: Jul. 27, 2021

Related U.S. Application Data
(60) Provisional application No. 63/057,161, filed on Jul. 27, 2020.

(51) Int. Cl. F23G 1/00; F23J 15/02; F23G 5/08; F23G 5/10; H05B 6/80; F27D 7/02

(52) U.S. Cl. CPC F23G 1/00; F23J 15/025; F23G 5/085; F27D 2007/063; H05B 6/80; F27D 7/02; F23G 5/10

(57) ABSTRACT

A system and method for plasma treatment comprises a radiofrequency chamber, a microwave source configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber. The systems and methods can be used for treatment of various treatment flows.

### CROSS REFERENCE TO RELATED PATENT APPLICATIONS

This patent application claims the priority and benefit, under 35 U.S.C. § 119(e), of U.S. Provisional Patent Application Ser. No. 63/057,161, filed Jul. 27, 2020, and titled “METHODS AND SYSTEMS FOR RADIOFREQUENCY PLASMA PLUME GENERATION”. U.S. Provisional Application Ser. No. 63/057,161 is incorporated herein by reference in its entirety.

### TECHNICAL FIELD

Embodiments are generally related to the field of plasma generation. Embodiments are also related to the field of waste treatment. Embodiments are also related to the field of water treatment. Embodiments are further related to the field of solid waste treatment. Embodiments are also related to systems and methods for generating radiofrequency plasma plumes.

### BACKGROUND

In most current plasma based technologies, the plasma is electrically generated using either direct current, alternating current, or pulsed systems. These techniques utilize electrodes that are prone to failure over time. Electrodes fail due to exposure to the high thermal temperatures and the many chemical processes that take place within the discharge region. Plasma generating systems with electrodes therefore require electrode maintenance, replacement, and system adjustments to keep the system operational as the electrode degrades.

Typical plasma investigations reported in scientific journals utilize AC, DC, and some low power radiofrequency plasma sources that generate plasma plumes on the order of a few inches in length. The limited plasma plume generated by these systems greatly restricts the applications associated with these systems.

Another approach for creating plasma makes use of radiofrequency induced power sources. Radiofrequency sources have existed since the mid-1950s. Various improvements to the technology have developed over time. The basic operating principle is that the radiofrequency source oscillates the electric field at a designated source frequency in which the electrons gain energy via the electric field. After sufficient energy gain, energetic electrons collide with the neutral gas particles and ionize the gaseous particles, thus creating a plasma.

There is an ever-growing need for complex material handling systems that provide versatility for material treatment, in an efficient and inexpensive manor. As such, the embodiments disclosed herein describe such systems and associated methods that employ radiofrequency wave generation in order to sustain a plasma for select material treatment and handling.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for generating plasma.

It is another aspect of the disclosed embodiments to provide a method, system, and apparatus for controlling a generated plasma.

It is another aspect of the disclosed embodiments to provide a method, system, and apparatus for generating and controlling plasma using a magnetron as a radiofrequency source.

It is another aspect of the disclosed embodiments to provide a method, system, and apparatus for treating fluids such as potable or unpotable water.

It is another aspect of the disclosed embodiments to provide a method, system, and apparatus for bulk activated water treatment for agricultural purposes.

It is another aspect of the disclosed embodiments to provide a method, system, and apparatus for treating solid waste.

It is another aspect of the disclosed embodiments to provide a method, system, and apparatus for plasma-based cremation.

The aforementioned aspects and other objectives and advantages can now be achieved as described herein. In an exemplary embodiment, a system and/or apparatus for generating plasma comprises a radiofrequency chamber, a microwave radiofrequency source configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber.

In an embodiment, a system comprises a radiofrequency chamber, a microwave source configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber. In an embodiment, the microwave source comprises a magnetron. In an embodiment the system comprises a compressed gas assembly configured to supply compressed gas to the radiofrequency chamber. The compressed gas assembly can comprise at least one of: a gas compressor and/or a pressurized gas tank and a regulator configured to regulate gas flow to the radiofrequency chamber. In an embodiment, the compressed gas comprises at least one of Argon, Oxygen, Helium, Carbon dioxide, breathable air, Methane, and Hydrogen. In an embodiment the system comprises a pump configured to deliver the treatment flow into the reaction chamber. In an embodiment the system further comprises at least one mister in fluidic communication with the pump and disposed in the reaction chamber, the mister configured to dispense the treatment flow in the reaction chamber. In an embodiment, the system further comprises a vapor conduit connected to the reaction chamber and a condenser connected to the vapor conduit. In an embodiment, the system comprises a clean fluid storage tank connected to the condenser, and a gas recirculation assembly associated with the clean fluid storage tank configured to recirculate excess gas to the radiofrequency chamber. In an embodiment, the system further comprises a clean water reservoir in the reaction chamber, a water monitoring system, and a pump configured to pump clean water from the clean water reservoir to an irrigation system according to input from the water monitoring system. In an embodiment, the reaction chamber further comprises an animal remains crematorium. In an embodiment, the system further comprises an exhaust valve for venting vapor generated in the reaction chamber. In an embodiment, the system further comprises a storage tank for collecting gaseous exhaust from the condenser, a gaseous vapor monitoring system, and a gaseous filtration system configured to supply the gaseous exhaust to a turbine. In an embodiment, the gaseous filtration system further comprises a Sabatier reaction cell.

In an embodiment, a plasma generating apparatus comprises a radiofrequency chamber, a magnetron configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber. In an embodiment, the plasma generating apparatus comprises a compressed gas assembly configured to supply compressed gas to the radiofrequency chamber, the compressed gas comprising at least one of: Argon, Oxygen, Helium, Carbon dioxide, breathable air, Methane, and Hydrogen. In an embodiment, the plasma generating apparatus further comprises a pump configured to deliver the treatment flow into the reaction chamber, and at least one mister in fluidic communication with the pump and disposed in the reaction chamber, the mister configured to dispense the treatment flow in the reaction chamber. In an embodiment, the plasma generating apparatus further comprises a vapor conduit connected to the reaction chamber, a condenser connected to the vapor conduit, a clean fluid storage tank connected to the condenser, and a gas recirculation assembly associated with the clean fluid storage tank configured to recirculate excess gas to the radiofrequency chamber. In an embodiment, the reaction chamber further comprises an animal remains crematorium.

In an embodiment, a system comprises a radiofrequency chamber, a microwave source configured to provide energy to the radiofrequency chamber, a reaction chamber configured to accept a treatment flow, and a plasma dispensation assembly configured in the reaction chamber, the plasma dispensation assembly being powered by energy from the radiofrequency chamber. In an embodiment, the system further comprises a compressed gas arrangement configured to provide gas to the radiofrequency chamber.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an embodiment;

FIG. 4 depicts a radiofrequency source system, in accordance with the disclosed embodiments;

FIG. 5 depicts a plasma-based water treatment system, in accordance with the disclosed embodiments;

FIG. 6 depicts a plasma-based bulk activated water treatment system, in accordance with the disclosed embodiments;

FIG. 7 depicts a plasma-based solid waste treatment system, in accordance with the disclosed embodiments;

FIG. 8 depicts a plasma-based cremation system, in accordance with the disclosed embodiments; and

FIG. 9 depicts steps associated with a method for generating plasma, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “microwave” as used herein, refers to a particular radiofrequency wave generating mechanism, but does not exclude any other radiofrequency wave generating systems.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

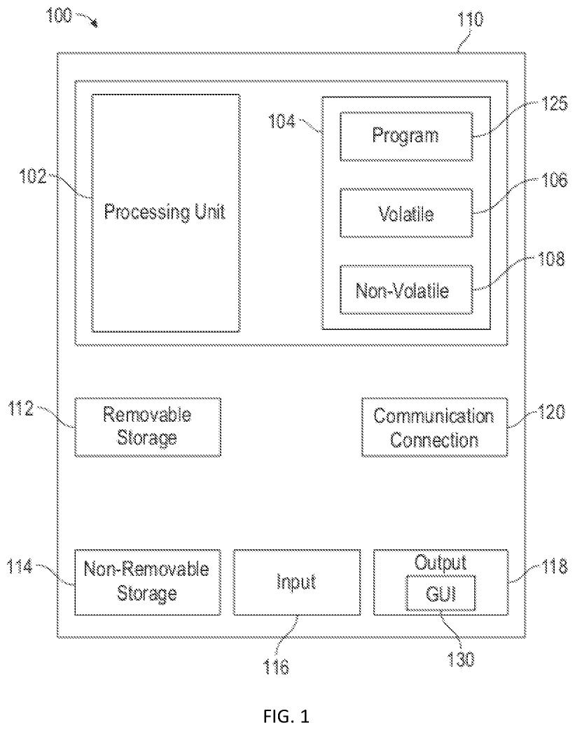

FIGS. 1-3 are provided as exemplary diagrams of data-processing environments in which embodiments disclosed herein may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108.

Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

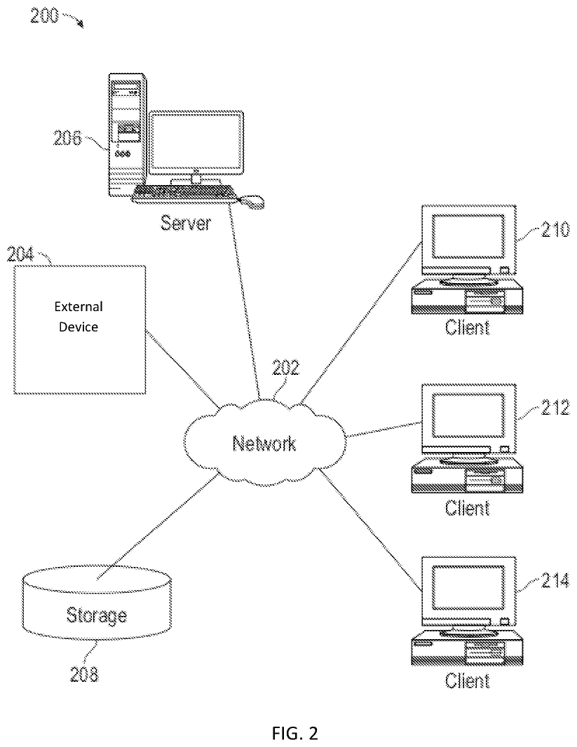

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present embodiments may be implemented. Network data-processing system 200 is a network of computers or other such devices such as mobile phones, smartphones, sensors, detection devices, controllers and the like in which embodiments may be implemented. Note that the system 200 can be implemented in the context of a software module such as program module 125. The system 200 includes a network 202 in communication with one or more clients 210, 212, and 214. Network 202 may also be in communication with one or more devices 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as a controller, actuator, magnetron, RF device, control system or other such device 204, and a memory storage unit such as, for example, memory or database 208. It should be understood that device 204 may be embodied as a detector device, microcontroller, controller, receiver, transceiver, or other such device.

In the depicted example, external device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and external device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments disclosed herein.

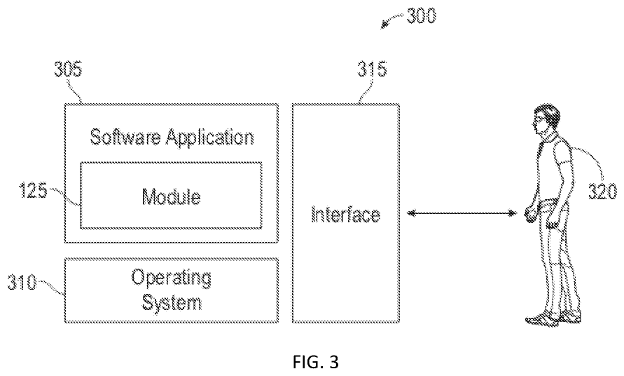

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, 3D printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

The embodiments disclosed herein make use of a versatile system that generates a radiofrequency wave generated plasma plume for various applications. Radiofrequency induced power sources, as disclosed herein, are efficient and inexpensive when compared to energies required by DC, AC, or pulsed systems. The embodiments include systems and methods used to generate a plasma that is capable of treating a volume throughput of various wastes, liquids, or even for cremation. The plasma can generate temperatures greater than 10000 K, and associated thermal energy, as well as reactive chemical species. The plasma can be generated by injecting a feedstock gas blend and radiofrequency energy from a radiofrequency source such as a magnetron, into a low RF impedance tube. A central principle of the disclosed embodiments, is that the plasma plume can be tightly controlled by manipulating the gas flow rate, gas flow composition, and power levels of the RF energy according to the specific application, as further detailed herein. In general, the gas blend, when converted into plasma, can emit across the UV spectrum. The plasma can thus be used for sterilization while also creating highly radical species. The plasma can be ejected from the low impedance RF tube into an application specific reaction chamber.

In certain embodiments, the system can be used for wastewater treatment applications. In such embodiments, a chamber can be lined with misters that disperse contaminated water in a treatment vessel. For plasma activated water embodiments, the plasma can be submerged in a water reservoir. In solid waste disposal applications, conversion occurs in a reaction vessel. In plasma cremation applications, an appropriately sized crematorium reaction cell can be used.

In any such application, the plasma interacts with the treatment medium in various chemical and thermal processes. The chemical processes are generated and controlled with the plasma generated charged species. For example, in certain embodiments, air plasma creates positive and negative oxygen and nitrogen molecules and atoms, opening chemically reactive pathways. The highly electronegative oxygen atoms have the ability to the break chemical bonds of the interacting media. The other plasma species also promote atomic chemical reactions from the now broken bonds and freed charged particles.

In addition to chemical processes, the energy of the electrons within the plasma are on the order of a few to many electron-volts (˜11600 K per electron volt). The high temperatures generated within the plasma promote thermal degradation of bonds through heating and allow for the melting and reforming of metals. Once the desired outcome is achieved, the cleaned and stored waste or remains may be collected or handled appropriately either by dumping treated effluent directly into the municipal waste stream, e.g. a sewage line, or otherwise disposing of the waste material.

In certain embodiments, the sterilized steam can be used for various purposes and the byproduct gasses can be recaptured for various purposes, such as auxiliary power generation. The embodiments provide a single step sterilization solution intended to improve overall cleanliness, reduce chemical reliance, improve efficiencies of treatment systems, reduce form factors, and provide efficient alternatives to current technologies.

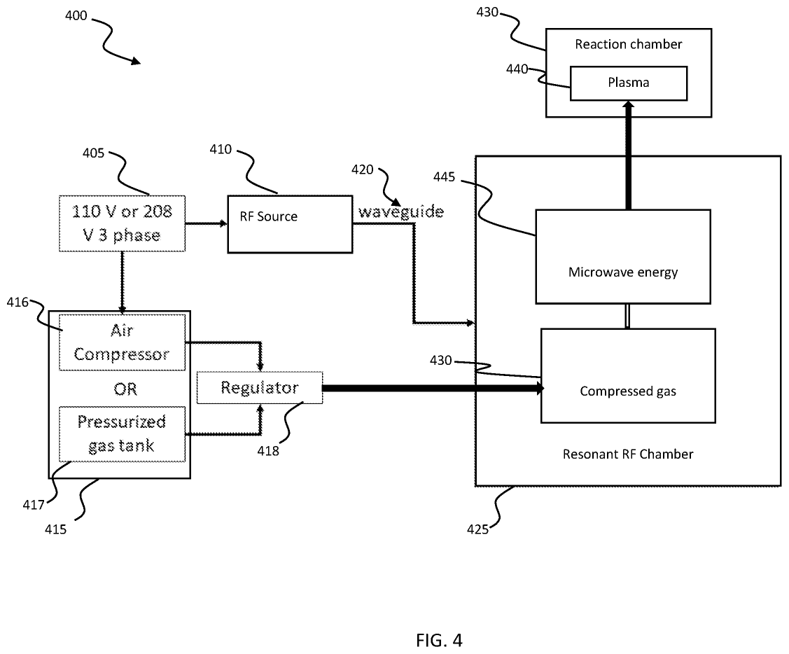

FIG. 4 illustrates an exemplary embodiment of a radiofrequency source system 400 in accordance with aspects of the systems disclosed herein. The radiofrequency source system 400 can generally include a 3 phase DC voltage source 405. The voltage source 405 can provide a potential at 110 V or 208 volts according to design aspects. The voltage source 405 can provide power to a radiofrequency (e.g. microwave) source 410 and/or a compressed gas arrangement 415.

The radiofrequency (RF) source 410 can be a magnetron. Magnetrons are generally configured to accept a DC power supply and generate radiofrequency waves. Magnetrons work by using electromagnetic interactions. Openings in the magnetron block hold oscillating electromagnetic waves. The frequency of the radiofrequency waves can be controlled according to the properties of the openings in the block. The magnetron can thus be used generate a radiofrequency signal from the DC power source. The resulting radiofrequency waves are then provided as input to a resonant RF chamber 425 via a waveguide 420.

The DC source 405 can also be used to power the compressed gas arrangement 415. The compressed gas arrangement 415 can comprise an air compressor 416 and/or a pressurized gas tank 417 either or both of which can be connected to a regulator 418 to control the flow of gas. Output from the regulator 418 can be connected to the resonant RF chamber 425 via high pressure fittings configured to safely deliver the compressed gas from the air compressor 416 and/or the pressurized gas tank 417. In certain embodiments, the regulators can include mass flow controller systems, valves, and standard regulators. The gas flow rates will be selected based upon the embodiment of the system and desired outcomes. The pressurized gas systems can further include particulate filters to prevent possible valve issues and contaminant buildup in the mass flow controllers, valves, and regulators.

The magnetron is used to generate the radiofrequency waves required for the plasma source. The waves propagate and increase the electric field in the resonant RF chamber 425. As the electric field increases, the field strength surpasses the ability of the molecule to retain its electrons in orbit. The molecule then becomes ionized. After a period of time, the molecules may recombine with electrons to become a neutral particle once again. As the rate of ionization surpasses the rates of recombination and diffusion, a plasma is formed. This fourth state of matter is considered to be a group of charged and neutral particles in an excited state with the ability for collective motion. In certain embodiments, the resonant RF chamber 425 can comprise a low impedance ceramic tube, or other such discharge tube, where the compressed gas and radiofrequency waves are contained. The RF chamber 425 serves as the location in which the electric field is enhanced to the point of plasma production.

The radiofrequency energy 445 can be introduced to the compressed gas 435 and dielectric medium in order to generate plasma 440 in the reaction chamber 430. The radiofrequency waves generated by the magnetron are transported to the reaction chamber via the waveguide structure 420, passing through a selected radiofrequency window. These windows allow energy to be transported through the medium while protecting the operation of the magnetron system.

In certain embodiments, the system 400 will use the magnetron to generate plasma at a specified frequency. The magnetron or other radiofrequency generating system can be selected for plasma generation such that the plasma parameters meet the requirements for a specific application. This is done by manipulating the feedstock gas mixture, gaseous flow rates, and radiofrequency power applied to the system. Manipulation of these systems may be automated based upon in-situ plasma characteristic measurements which in turn provide feedback to a computer monitoring system. The computer monitoring system may be programmed for automatic adjustment of system operation for desired outcomes, or provide a GUI for operator adjustment of the system. Parameters that can be modified via the magnetron operation include electron temperatures, neutral gas temperature, absorbed power, reflected power, and the volume of plasma.

For instance, in agricultural applications increasing nitrogen feedstock gas content increases the observed production of nitrates and nitrites in the water. Nitrates and nitrites can be a fertilizer for most plants, and therefore these levels within water may be controlled by the aforementioned methods. The specific plasma parameters for each embodiment of the system are based upon the desired outcome of the system whether waste conversion or fertilization and the by-product gaseous compounds.

In addition to the utilization of a magnetron for volume plasma generation, in order to control the reactive species generated in the plasma volume, various gaseous mixtures of the feedstock gas can be used. Hence the embodiments disclosed herein employ the use of a power microwave in the form of a plasma torch to efficiently generate a plasma plume length on the order of greater than a few feet in length. This large non-fusion plasma greatly increases the interaction volume of the plasma plume and therefore increases throughput capacity.

The various feedstock gases can include noble gases such as argon, helium, xenon as well as known diatomic gasses such as O₂ or N₂ and even known compounds such as carbon dioxide, or any combination thereof. Argon gas-based plasma has beneficial sterilization effects as the generated plasma emits ultra-violet light. Oxygen based plasma produces ozone, among other oxygen species, which are highly reactive. Ozone generation via the disclosed method is an alternative option for municipal water sterilization. Nitrogen gas-based plasmas generate nitrates and nitrites within water that interacts with the nitrogen plasma medium, allowing the water to become “activated” with different properties than found in the conventional supply.

The gaseous commodity that passes through the plasma region may be controlled via the pressure regulator 418, along with common mass flow controller components. A pressure regulator attached to the gaseous cylinder sets the maximum pressure allowed to enter the gas feed lines. The gas flow and pressure are further controlled via components known as mass flow controllers. Mass flow controllers are systems calibrated based upon the atomic mass and composition of the feedstock gas. Mass flow controllers regulate flow rates based on controller specific methods. Controlling the input gases with the plasma parameters allows for manipulation of the complex plasma treatment process.

A core component of the system, and associated methods, is the application of a microwave generated plasma for a desired volume plasma and therefore increased system throughput. Plasma generated by this method can have localized thermal energy (for example greater than 10000 K), chemically reactive species, and energetic emitted photons while also being an efficient process when compared to other plasma generating systems. The thermal temperature is localized due to the nature of plasma diffusion and recombination. Diffusion and recombination are methods in which the charged species of the plasma neutralize. In order for a plasma to exist, plasma ionization processes must occur at a higher rate than recombination and diffusion. Therefore, it localizes the plasma and high plasma temperatures to where the designed electric field enhancement is located (within the dielectric medium). The basis of plasma generation using the aforementioned methodology allows plasma to be generated for a variety of applications.

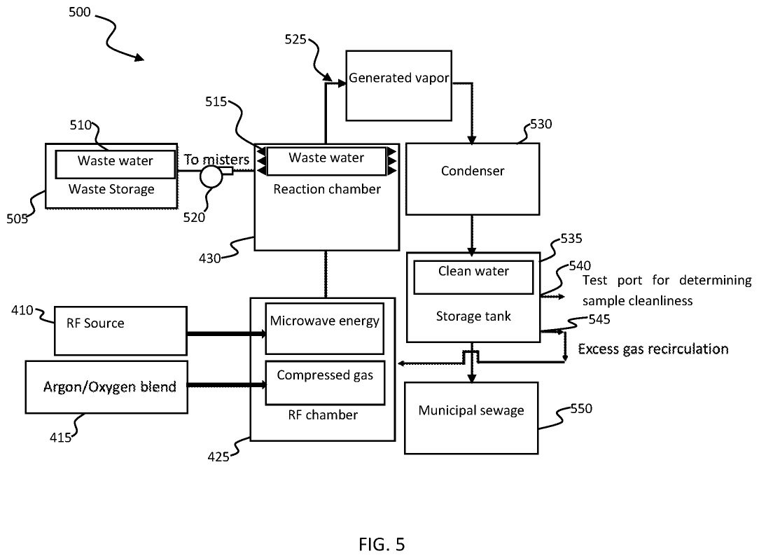

An exemplary application of the microwave source system 400 is illustrated in FIG. 5, as a water treatment system 500. The system 500 includes the microwave source 410 and gas distribution system 415 which provide compressed gas and microwave energy to the RF chamber 425. The resulting plasma 440 is generated in the reaction chamber 430.

In this embodiment, the reaction chamber is outfitted with one or more misters 515. A waste storage tank 505 can provide waste fluid 510 (e.g. waste water) to the misters 515. The waste fluid can be driven by pump 520. The misters 515 can comprise mounted nozzles within the housing structure, configured for dispersing liquid into the plasma. The flow rate of the nozzles may be adjusted by the pressure of the pumping system and therefore control the throughput of the wastewater. The adjustment of flow rate may be done via a manual valve or an automated valve controlled via a computer. The system can include flow rate sensors as a monitoring system. Flow rate monitoring equipment can be provided along with computer programs implemented in certain embodiments. The waste stream, upon exiting the nozzle array, will impact the plasma plume of high thermal temperatures and reactive chemical species. The combination of these properties will reduce or eliminate the harmful compounds via chemical and thermal processes that are more efficient than conventional chemical or distillation processes.

This water treatment solution is more efficient than conventional chemical or distillation processes for various reasons. It is more efficient than chemical processes as it has the reactive species and high temperatures needed to break chemical bonds and compounds that chlorination or fluorine additives may not address. This also removes the logistical needs of chemical shipment, handling, implementation, removal, and maintenance. When compared to conventional distillation processes, plasma generation localizes the high temperatures to the plasma plume region and therefore directly transfers energy to the water as opposed to ambient heat loss of a boiler style distillation process.

The plasma interaction with the waste water creates a plasma generated vapor in vapor tubing 525. The vapor tubing 525 can comprise stainless steel tubing or other such tubing which can be held at a slight pressure. In other embodiments, the tubing can be configured to operate at increased or decreased pressure. Any contamination originally present in the waste water is removed from the vapor. The vapor tubing 525 leads to a condenser 530 where the vapor is condensed back into liquid form (e.g. clean water). The condenser 530 can then be fluidically connected to a storage tank 535 where clean fluid can be stored. The storage tank 535 includes a test port 540 where samples from the clean water can be taken for testing.

In certain embodiments, the water can be held in the storage tank 535 to allow time for testing via various processes in order to determine cleanliness. In some cases, the water can be exhausted into the environment as long as it is tested and passes environmental regulations and protections. In other embodiments, a streak test can be performed to determine water cleanliness. The storage tank 535 can then empty into municipal sewage 550.

The storage tank 535 can further include a gas port 545 with a pressure fitting which is connected to the RF chamber. Excess gas in the storage tank 535 can be provided back to the RF chamber 425 for reuse. The gas port 545 allows for the exhausted gas to re-enter the plasma region for a second treatment, if not passing cleanliness testing regulations, or to remove the need to have an external feedstock gas beyond system start-up. A feedstock gas may be used to start plasma ignition and once treatment begins, recirculation of the plasma gas removes excess commodity use and reduces operational logistics.

The plasma applied in the waste treatment system 500 allows for significantly higher volume throughput for industrial or municipal requirements. The plasma plume can be injected from the discharge region with a significant gaseous flow rate into the wastewater delivery reaction chamber 430. A significant gaseous flow rate of a particular compound may range from a few standard cubic centimeters per minute (sccm) to up to a few hundred or thousands of standard liters per minute (slpm) The plasma plume can be of significant length, penetrating into the reaction vessel.

A key to the system 500 is the adaptability of the radiofrequency source 410 to adjust the plasma plume length so that it correlates with the nozzle-based wastewater configuration in the reaction chamber 430. Changing the source to change the frequency and/or power, will change the plasma plume length and diameter. The volume of plasma generation allows for an array of wastewater dispersive nozzles with treatment throughput of the system.

For example, in certain embodiments, analytical methods can be used to derive an initial estimate of plasma volume required. With this as a starting point, the exact size of the plume can be adjusted experimentally via real-time monitoring of the plume and the characteristics of the treated fluid. As the plasma changes on a nanosecond time scale, Sensors are used to evaluate time-averaged parameters. From this data, analytical methods are used to determine a reasonable estimate of expected properties. Through experimentation, actual values are determined and therefore reproducible by identical system design and operation.

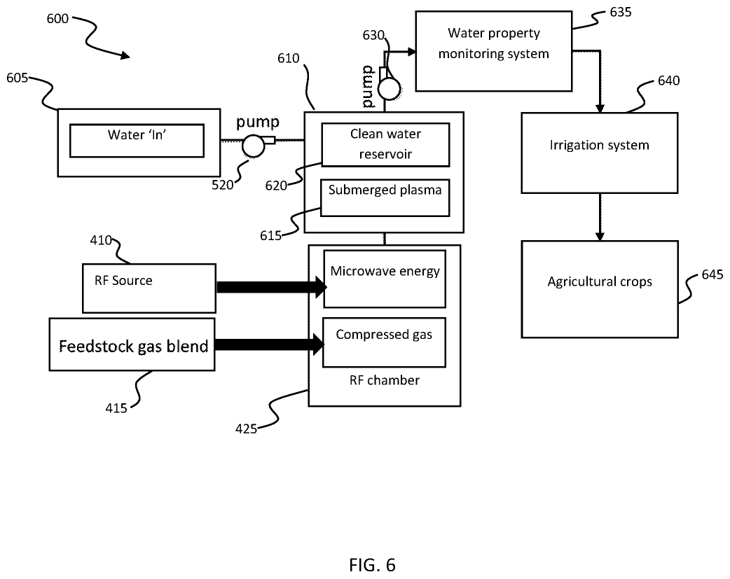

Another unique adaption of the treatment system 400 is the generation of plasma activated water for agricultural benefits with the bulk activated water treatment system 600 illustrated in FIG. 6. This particular application of radiofrequency plasma generation allows for large volume water activation via the radiofrequency plasma source injecting the plasma reactive species into the water. In this embodiment, a water source 605 can be pumped with pump 520 to a reaction vessel 610. The water source 605 can comprise a potable or non-potable source such as a well, river, stream, ditch, diversion, pond, lake, etc. The reaction vessel 610 is configured with an inlet port so that water can be pumped from the water source 605.

Water in the reaction vessel is held in a clean water reservoir 620. The plasma 615 generated in this embodiment can be submerged in the water in the clean water reservoir 620. The plasma can be used to adjust the water pH levels, nitrate and nitrite concentrations, conductivity, and peroxide levels based upon the plasma properties and feedstock gases used to generate the submerged plasma.

The embodiment of plasma activating water differs from water treatment according to the way in which the plasma interacts with the water. For water treatment, the misting nozzles allow for plasma to gasify the liquid waste input and therefore breakdown waste components. In this embodiment, the plasma plume 615 will carry reactive species into the water via a submerged plasma plume, therefore allowing the reactive species to interact with the water and form new compounds such as nitrates, nitrites, and peroxides. For example, the levels of nitrates and nitrites in the water may be manipulated by the amount of time the plasma is allowed to interact with the water, the feedstock gas blend (i.e. how much nitrogen and oxygen or fed into the plasma plume), and radiofrequency power input into the system.

The output of the high power microwave plasma generation region limits the amount of vaporization of the liquid forcing all of the reactive plasma species through the water. This causes the gaseous molecules to be solvated into the liquid, modifying the water properties. A water property monitoring system 635 can be used to monitor and adjust the water properties. This system can be comprised of real-time measurements of selected compounds such as nitrates, nitrites, conductivity, or pH. These monitors can be provided to a computer program that will adjust the system operational settings to maintain or adjust the output water characterization. Benefits of activated water may include enhanced root development, faster germination rates and percentages, longer shoots, and higher yields to name a few.

After receiving the plasma treatment, the water in the clean water reservoir can be pumped with pump 630 to an irrigation system 640. The irrigation system 640 can comprise a standard irrigation system which can deliver the treated water to a crop 645. The bulk activated water treatment system 600 thus allows for large volume water activation for agricultural applications.

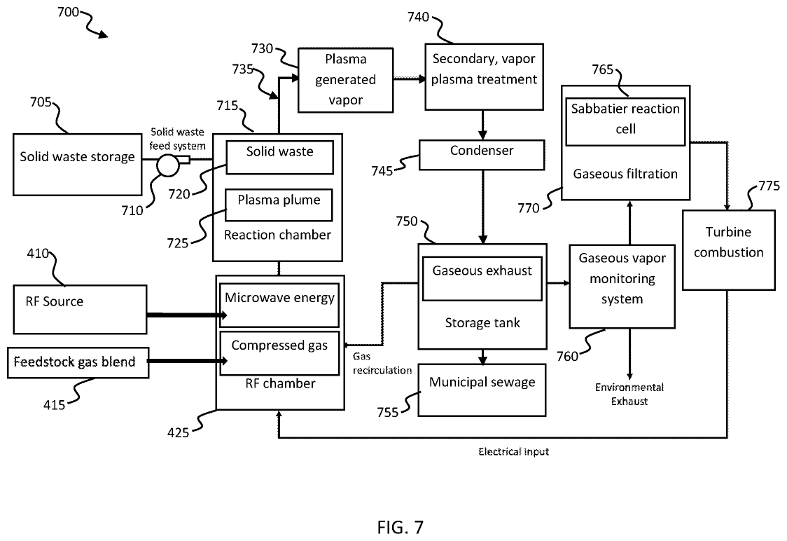

FIG. 7 illustrates another embodiment of a solid waste treatment system 700 incorporating a microwave source system 400. This system can be employed for treatment of sewage, or other such solid waste. The solid waste feed system 700 is for solid waste gasification and off-gas capture. The high power microwave plasma generation as disclosed herein, enables a high volume throughput of solid waste treatment via gasification of the waste.

The gasification of waste is achieved by generating plasma using the microwave source 410 and gas distribution system 415. Solid waste stored in solid waste storage 705 can be provided to a reaction chamber 715 via pump 710. The plasma plume 725 interacts with the solid waste 720 within the reaction chamber 715. It should be appreciated that this embodiment may result in additional off-put by-product gases. In certain embodiments, such gasses can be captured, separated, and used for combustion with a small scale turbine system to generate electrical power that may be used to augment power to the system.

Here (as in the wastewater treatment application), the larger volume of plasma allows for an increased waste treatment throughput of the system and may be achieved by increasing the microwave power as well as modifying the frequency of the system. The plasma plume 725 vaporizes the solid waste 720 in the reaction chamber 715.

The plasma generated vapor 730 (or gasified waste) can be transported via conduit 735 to a secondary treatment 740. The secondary treatment 740 can comprise a plasma corona discharge and/or a packed bed dielectric barrier discharge in order to further remove any possible volatile organic chemical gases or other toxic fumes from the plasma generated vapor 730. The corona and/or packed bed dielectric barrier discharge provides energetic ions and electrons in the gaseous exhaust of the initial waste treatment process. The plasma discharges may be generated utilizing ac, dc, or pulsed power sources. This allows for any large gaseous molecules to be further broken down, ensuring a greater by-product output of non-toxic compounds such as CO₂, CH₄, H₂O verses possible dioxins and furans. Additionally, the plasma has localized thermal energy that further breaks down harmful compounds.

The twice treated vapor is then provided to a condenser 745, where it is condensed into a liquid form. The resulting gaseous and liquid effluent is provided to a storage tank 750. The storage tank 750 can include a gas port such that gaseous exhaust can be provided back to the RF chamber 425 via high pressure gas fittings. Liquid waste can be sent to a municipal sewage system 755. The recirculated gases can be the by-products of the previous treatments, which limits the need of an external feedstock gaseous commodity. In order to recirculate this gas, an exhaust and recirculation system of fans, including compressors can be implemented.

The storage tank 750 can further be connected to a gaseous vapor monitoring system 760. The treatment of the solid waste renders the off gases inert and environmentally friendly for general exhaust. The gaseous vapor monitoring system 760 can simply vent such environmental exhaust. The gaseous vapor monitoring system 760 can look at compounds such as nitrous oxides that may be produced as a chemical by product. The levels of NOₓ can be recorded and provided to a computer system, such as computer system 100, that may then manipulate the plasma according to the aforementioned methods to reduce the measures NOₓ levels. The computer monitoring system can evaluate the input from the sensor to identify levels of toxic compounds observed in system design and testing as measured by a Fourier transform infrared spectroscopy system. These compounds are measured and compared to environmental regulations and restrictions. These limits can be pre-programmed into the computer monitoring system and when the live monitoring system sees the compounds levels rise, it would implement automated measures such as adjusting feedstock gas mixtures, flow rates, or power levels to lower the measured levels.

Other gas can be captured and recycled. The recycled gases can be used as the feedstock gas for the solid waste conversion plasma generation or undergo a chemical process known as a Sabbatier reaction in order to make methane gas. This can be achieved by providing such gas to a gas filter 770 and associated Sabbatier reaction cell 765. Output methane gas from the Sabbatier reaction cell 765 can be provided to a turbine 775. Output power from the turbine 775 can be supplied back to the RF chamber 425. Gaseous separation techniques may involve gas fractioning approaches that include Joule-Thomson effect throttling valves, permeable gas membranes, centrifugal separation, or mass separation via electric fields. Once the gas has been separated, combustible gases such as methane may be fed into a standard turbine electrical system such as those used in natural gas generators.

Aspects of the embodiments can thus be used to provide high volume throughput which can be adjustable. It should be further appreciated that the use of multiple plasma generating systems in series can be used to increase the overall plasma waste interaction time while maintaining a steady input of solid waste and output of treated waste in a gaseous stream. Multiple plasma plume systems may be put in a single reaction chamber in order to increase the overall plasma volume. The exhaust gases may exit via a single exhaust port and are monitored via the aforementioned methods. The systems in parallel can then all be adjusted via a parallelized control system that can adjust feedstock gas mixtures, flow rates, and power levels.

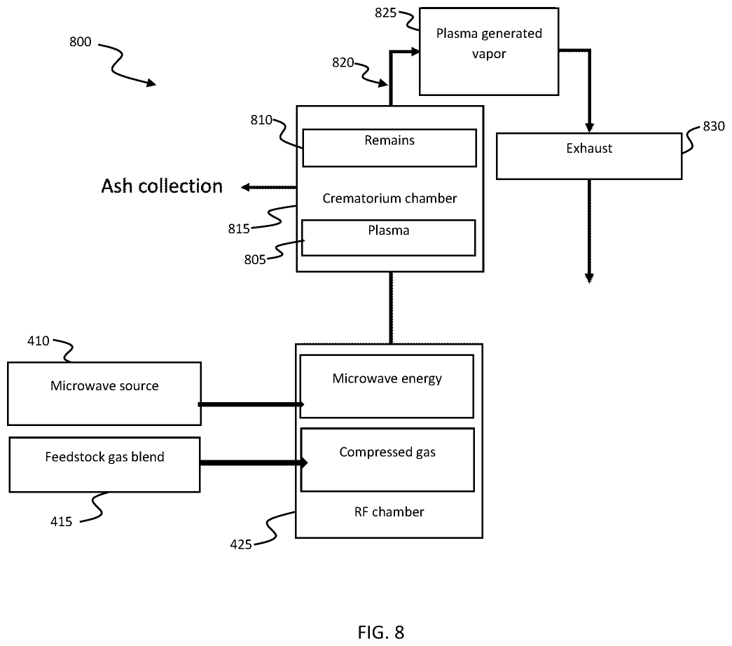

In another embodiment, a plasma cremation system 800 can take advantage of aspects of the microwave source system 400 as illustrated in FIG. 8. In this embodiment, remains 810 can be placed in crematorium chamber 815. The remains 810 can be subject to the plasma plume 805. The plasma plume 805 will vaporize the remains 810. The plasma generated vapor 825 can be vented through exhaust 830 which can be attached to the crematorium chamber via conduit 820.

The employment of the high power microwave plasma with a significant plume length can result in high electrical to thermal energy transfer. Among numerous advantages, the embodiment only requires electrical power as opposed to the necessary gaseous or liquid fuel in conventional incineration systems. In this instance a single plasma generation of very high power would allow for cremation of remains 810 or alternatively multiple torches may allow for a more controlled cremation process with an overall reduction of peak power consumption.

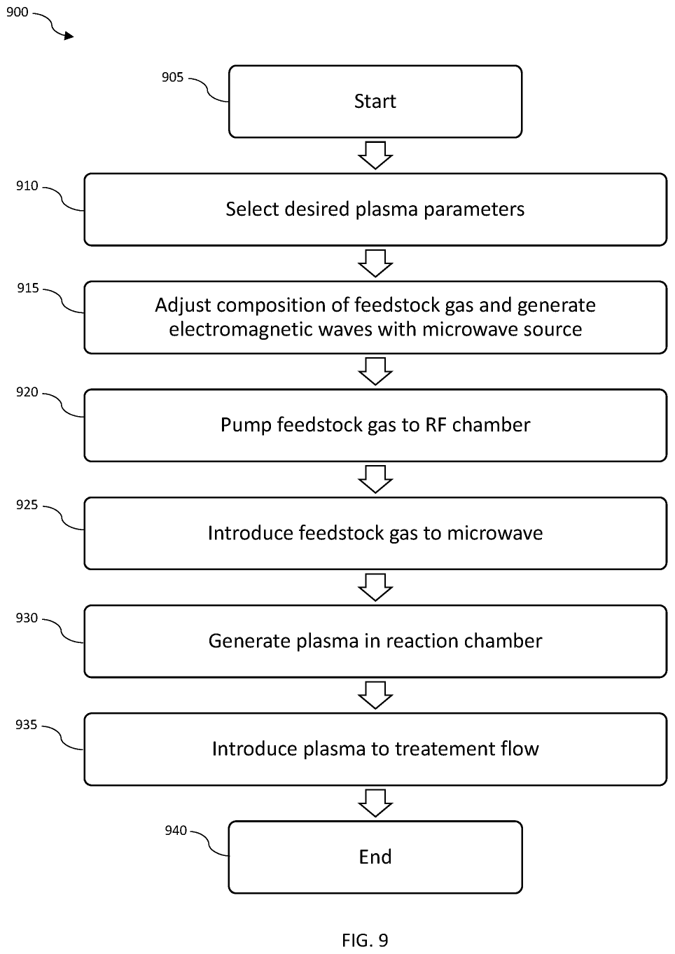

FIG. 9 illustrates, steps associated with a method 900 for generating plasma with an RF source in accordance with the embodiments disclosed herein. The method starts at 905. At step 910, the desired plasma parameters can be selected. The parameters associated with the plasma may be selected according to the application. The composition of gaseous feedstock and generation of electromagnetic waves, at step 915, can be based on the desired plasma parameters established in step 910. In certain embodiments this step can be automated with a program product associated with the system.

At step 920, the feedstock can be supplied to the RF chamber. Next, at step 925 the feedstock gas can be introduced to the microwaves. The resulting interaction will generate plasma at step 930, in the reaction chamber. At this point, the plasma can be directed into the treatment flow as shown at step 935. It should be appreciated that the treatment flow as described herein could be fluid, potable or non-potable water, solid waste, and/or remains. The method ends at 940.

Based on the foregoing, it can be appreciated that a number of embodiments, preferred and alternative, are disclosed herein. In an embodiment, a system comprises a radiofrequency chamber, a microwave source configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber. In an embodiment, the microwave source comprises a magnetron.

In an embodiment the system comprises a compressed gas assembly configured to supply compressed gas to the radiofrequency chamber. The compressed gas assembly can comprise at least one of: a gas compressor and/or a pressurized gas tank and a regulator configured to regulate gas flow to the radiofrequency chamber. In an embodiment, the compressed gas comprises at least one of Argon, Oxygen, Helium, Carbon dioxide, breathable air, Methane, and Hydrogen.

In an embodiment the system comprises a pump configured to deliver the treatment flow into the reaction chamber. In an embodiment the system further comprises at least one mister in fluidic communication with the pump and disposed in the reaction chamber, the mister configured to dispense the treatment flow in the reaction chamber.

In an embodiment, the system further comprises a vapor conduit connected to the reaction chamber and a condenser connected to the vapor conduit. In an embodiment, the system comprises a clean fluid storage tank connected to the condenser, and a gas recirculation assembly associated with the clean fluid storage tank configured to recirculate excess gas to the radiofrequency chamber.

In an embodiment, the system further comprises a clean water reservoir in the reaction chamber, a water monitoring system, and a pump configured to pump clean water from the clean water reservoir to an irrigation system according to input from the water monitoring system.

In an embodiment, the reaction chamber further comprises an animal remains crematorium.

In an embodiment, the system further comprises an exhaust valve for venting vapor generated in the reaction chamber.

In an embodiment, the system further comprises a storage tank for collecting gaseous exhaust from the condenser, a gaseous vapor monitoring system, and a gaseous filtration system configured to supply the gaseous exhaust to a turbine. In an embodiment, the gaseous filtration system further comprises a Sabatier reaction cell.

In an embodiment, a plasma generating apparatus comprises a radiofrequency chamber, a magnetron configured to provide energy to the radiofrequency chamber, a reaction chamber configured to accept a treatment flow, a plasma dispensation assembly configured in the reaction chamber, the plasma dispensation assembly being powered by energy from the radiofrequency chamber, and a collection chamber for collecting treated material from the reaction chamber.

In an embodiment, the plasma generating apparatus comprises a compressed gas assembly configured to supply compressed gas to the radiofrequency chamber, the compressed gas comprising at least one of: Argon, Oxygen, Helium, Carbon dioxide, breathable air, Methane, and Hydrogen. In an embodiment, the plasma generating apparatus further comprises a pump configured to deliver the treatment flow into the reaction chamber, and at least one mister in fluidic communication with the pump and disposed in the reaction chamber, the mister configured to dispense the treatment flow in the reaction chamber.

In an embodiment, the plasma generating apparatus further comprises a vapor conduit connected to the reaction chamber, a condenser connected to the vapor conduit, a clean fluid storage tank connected to the condenser, and a gas recirculation assembly associated with the clean fluid storage tank configured to recirculate excess gas to the radiofrequency chamber.

In an embodiment, the reaction chamber further comprises an animal remains crematorium.

In an embodiment, a system comprises a radiofrequency chamber, a microwave source configured to provide energy to the radiofrequency chamber, a reaction chamber configured to accept a treatment flow, and a plasma dispensation assembly configured in the reaction chamber, the plasma dispensation assembly being powered by energy from the radiofrequency chamber. In an embodiment, the system further comprises a compressed gas arrangement configured to provide gas to the radiofrequency chamber.

It should be appreciated that variations of the above-disclosed and other features and functions, or alternatives thereof, may be desirably combined into many other different systems or applications. It should be understood that various presently unforeseen or unanticipated alternatives, modifications, variations or improvements therein may be subsequently made by those skilled in the art which are also intended to be encompassed by the following claims.

What is claimed is:

1. A system comprising:
a radiofrequency chamber;
a microwave source configured to provide energy to the radiofrequency chamber;
a reaction chamber configured to accept a treatment flow;
a plasma dispensation assembly configured in the reaction chamber, the plasma dispensation assembly being powered by energy from the radiofrequency chamber; and
a collection chamber for collecting treated material from the reaction chamber.

2. The system in claim 1 wherein the microwave source comprises a magnetron.

3. The system of claim 1 further comprising:
a compressed gas assembly configured to supply compressed gas to the radiofrequency chamber.

4. The system of claim 3 wherein the compressed gas assembly comprises:
at least one of: a gas compressor and/or a pressurized gas tank; and
a regulator configured to regulate gas flow to the radiofrequency chamber.

5. The system of claim 3 wherein the compressed gas comprises at least one of:
Argon;
Oxygen;
Helium;
Carbon dioxide;
breathable air;
Methane; and
Hydrogen.

6. The system of claim 1 further comprising:
a pump configured to deliver the treatment flow into the reaction chamber.

7. The system of claim 6 further comprising:
at least one mister in fluidic communication with the pump and disposed in the reaction chamber, the mister configured to dispense the treatment flow in the reaction chamber.

8. The system of claim 1 further comprising:
a vapor conduit connected to the reaction chamber; and
a condenser connected to the vapor conduit.

9. The system of claim 8 further comprising:
a clean fluid storage tank connected to the condenser;
a gas recirculation assembly associated with the clean fluid storage tank configured to recirculate excess gas to the radiofrequency chamber.

10. The system of claim 1 further comprising:
a clean water reservoir in the reaction chamber;
a water monitoring system; and
a pump configured to pump clean water from the clean water reservoir to an irrigation system according to input from the water monitoring system.

11. The system of claim 1 wherein the reaction chamber further comprises:
an animal remains crematorium.

12. The system of claim 10 further comprising:
an exhaust valve for venting vapor generated in the reaction chamber.

13. The system of claim 8 further comprising:
a storage tank for collecting gaseous exhaust from the condenser;
a gaseous vapor monitoring system; and
a gaseous filtration system configured to supply the gaseous exhaust to a turbine.

14. The system of claim 13 wherein the gaseous filtration system further comprises:
a Sabatier reaction cell.

15. A plasma generating apparatus comprising:
a radiofrequency chamber;
a magnetron configured to provide energy to the radiofrequency chamber;
a reaction chamber configured to accept a treatment flow;
a plasma dispensation assembly configured in the reaction chamber, the plasma dispensation assembly being powered by energy from the radiofrequency chamber; and
a collection chamber for collecting treated material from the reaction chamber.

16. The plasma generating apparatus of claim 15 further comprising:
a compressed gas assembly configured to supply compressed gas to the radiofrequency chamber, the compressed gas comprising at least one of:
Argon;
Oxygen;
Helium;
Carbon dioxide;
breathable air;
Methane; and
Hydrogen.

17. The plasma generating apparatus of claim 15 further comprising:
a vapor conduit connected to the reaction chamber;
a condenser connected to the vapor conduit;
a clean fluid storage tank connected to the condenser; and
a gas recirculation assembly associated with the clean fluid storage tank configured to recirculate excess gas to the radiofrequency chamber.

18. The plasma generating apparatus of claim 15 wherein the reaction chamber further comprises:
an animal remains crematorium.

19. A system comprising:
a radiofrequency chamber;
a microwave source configured to provide energy to the radiofrequency chamber;
a reaction chamber configured to accept a treatment flow; and
a plasma dispensation assembly configured in the reaction chamber, the plasma dispensation assembly being powered by energy from the radiofrequency chamber.

20. The system of claim 19 further comprising:
a compressed gas arrangement configured to provide gas to the radiofrequency chamber.
